(19) United States
(12) Patent Application Publication
(10) Pub. No.: US 2002/0004578 A1
(43) Pub. Date: Jan. 10, 2002

(54) Polyester compositions containing polar chain terminatos

(76) Inventors: Marcus David Shelby, Kingsport, TN (US); Timothy Edward Long, Blacksburg, VA (US); Marc Alan Strand, Kingsport, TN (US)

Correspondence Address: Cheryl J. Tubach, Eastman Chemical Company, P.O. Box 511, Kingsport, TN, 37662-5075, US

(21) Appl. No.: 09/791,112

(22) Filed: Feb. 22, 2001

Related U.S. Application Data
(60) Provisional application No. 60/197,436, filed on Apr. 14, 2000.

(51) Int. Cl. C08G 63/00

(52) U.S. Cl. 528/176; 528/183; 528/287; 528/361; 528/363; 528/365

(57) ABSTRACT

To increase the melt strength and increase high shear thinning of a polyester composition, a polar chain terminator that contains a nonionic group or an ionic group neutralized with a counterion is added at a level of 0.05 to 20 mole percent. Optionally, up to 2.0 mole percent of a tri-functional or greater branching agent is added to the polyester composition. Optionally, up to 30 mole percent of a polar midchain difunctional monomer that contains a nonionic group or an ionic group neutralized with a counterion is added. The polyester composition is based on 100 mole percent diacid component and 100 mole percent glycol component.

### CROSS-REFERENCE TO RELATED APPLICATION

This application claims the benefit of provisional application Ser. No. 60/197,436 filed Apr. 14, 2000.

### TECHNICAL FIELD OF THE INVENTION

This invention relates to polymeric materials that have high melt strengths and exhibit high shear thinning to enable processing ease in extrusion and injection molding operations. More particularly, this invention relates to certain polyester compositions that exhibit these characteristics.

### BACKGROUND OF THE INVENTION

Polyesters are notoriously difficult to process compared to many other polymers such as polyvinyl chloride (PVC), polyolefins, polystyrene and acrylics. This relative difficulty exists because polyesters have comparatively lower melt strengths and insufficient shear thinning resulting in a greater propensity for melt fracture if extruded at higher pressures. Similarly, injection molding of these polyesters is difficult because of the higher pressures required to fill the mold. Both melt strength and shear thinning are extremely important factors from the standpoint of film, sheet, fiber or profile extrusion. Further, these same factors are also influential in controlling cycle times during injection molding (e.g. the molding of preforms used for bottle blow molding). Since the other polymers suffer from one or more of their own disadvantages, polyesters would be ideal alternative materials in similar applications if processing hurdles for polyesters could be overcome.

Zero Shear Viscosity and Melt Strength

A viscosity curve for a given polymer, as shown in FIG. 1, has two regions of interest. One region is at very low shear rates in which the viscosity is highest. This is referred to as the “zero shear viscosity”, ηₒ. The zero shear viscosity (along with the elasticity of a polymer) defines the melt strength since the polymer is experiencing essentially a zero shear rate after exiting from the die. Thus, the higher the zero shear viscosity, the higher the melt strength.

Melt strength is a polymeric characteristic that describes one facet of the “processability” of a polymer. Melt strength is defined as the ability of a polymer to support its own weight in the molten state. For example, when extruded vertically from a die, a polymer with low melt strength will quickly sag and hit the floor; whereas, a polymer with high melt strength will maintain its shape for a much longer amount of time. Melt strength is critical to many processes such as extrusion blow molding, profile extrusion, and foam generation. For injection molding, melt strength is important in defining how quickly a molded part can be removed from the mold. Higher melt strength translates into shorter cooling and cycle times. With higher melt strength, the part can also be removed from the mold at a higher temperature. For profile extrusions, which are usually run horizontally, high melt strength is desired to reduce gravity-induced sagging that the polymer experiences upon exiting the die. To compensate for the sagging, profile extrusions are run utilizing a drawdown factor. Drawdown is defined in profile extrusion as the amount of thickness reduction between the die and the takeup system. Drawdown is expressed as the nominal thickness or width dimension at the die divided by the same dimension in the final part. For example, a typical polyester drawdown is about two. This means that the width of the final part is ½ that of the width at the die exit. The take-up force of the puller or winder causes drawdown as the melt exits the die. For higher melt strength polymers with greater resistance to sagging, the amount of drawdown required is less. PVC, a high melt strength polymer has a typical drawdown of about 1.25. Dies are easier to design and final part dimensions are more accurately maintained when using polymers with drawdowns approaching 1.0.

There are a number of quantitative and qualitative means for measuring melt strength. One standard test is disclosed in U.S. Pat. No. 4,398,022 wherein melt strengths for polyesters used in extrusion blow molding processes were measured at values between −10 and 10 percent. This same test is utilized herein and involves vertically extruding a polymer from a 0.1 inch (0.25 cm) diameter capillary die that is 0.25 inches (0.64 cm) long at a shear rate of 20 s⁻¹ up to a total length of 19 inches (49 cm). The extrudate is then cut near the die face. The resulting polymer strand is laid horizontally on a flat surface and allowed to cool at room temperature. The diameter 6 inches (15 cm) from the end of the strand (6-inch point) is then measured and expressed as a percentage change relative to the capillary diameter to give the melt strength. For example, if the strand diameter at the 6-inch point is 0.12 inches (30 cm), then the melt strength at that given melt temperature is 20 percent (i.e. MS=(0.12−0.1)/0.1×100). Similarly, the “die swell” is obtained by measuring the diameter at ½ inches (1.3 cm) from the end of the extrudate and expressing the die swell as a percentage change relative to the capillary diameter.

Polyesters may have a negative value for the melt strength since the 6-inch point could be less than the nominal diameter. This indicates a poor melt strength. For example, linear poly(ethylene terephthalate) modified with 1,4-cyclohexanedimethanol (PETG) having an inherent viscosity (IV) of 0.76 dl/g has been observed to have a melt strength of −4% at 200° C. and −24% at 220° C. Thus the 6-inch point was 4% smaller (200° C. sample) than the die opening. Typical melt strengths for PVC under standard processing conditions (160 to 200° C. processing temperature) are in the order of 20 to 30%. Achieving this melt strength with linear PETG would require an IV of around 0.95 dl/g. Thus, for applications in which melt strength is critical, polyesters will often not supplant these competitive polymers.

Another common melt strength test involves measuring the time period that an extrudate takes to reach a predetermined length below a die for a given flowrate/shear rate. While not standardized, this test provides an easy method for material comparison on a typical processing line and is used in some of the examples cited herein. Other non-standard melt strength tests such as measuring the degree of drooping in a horizontal profile extrusion line can also be applied giving a more application specific measure of melt strength.

High Shear Viscosity and Shear Thinning

With reference to FIG. 1, the other region of interest on the viscosity curve is in the high shear rate region. The polymer is “processed” in this region with shear rates in the die/extruder ranging anywhere from about 10 s⁻¹ to 1000 s⁻¹. As low of a viscosity as possible in this range is desired in order to reduce screw motor load and to minimize pumping pressure and melt fracture. Ease of flow at high shear rates is the second facet of the “processability” of a polymer. A high melt strength resin is not sufficient if the resin cannot be extruded and pumped through a die. Fortunately, most polymers exhibit at least some degree of viscosity reduction or “shear thinning” at higher shear rates, which aids in their processability. Without the shear thinning, an extruder running a high melt viscosity polymer would require extremely high motor loads and/or very high melt temperatures, both of which can lead to polymer degradation and excessive energy consumption.

Having a low viscosity at high shear rates (i.e. in the die) also serves to minimize the formation of melt fracture or “sharkskin” on the surface of the extruded part or article. Melt fracture is a flow instability phenomenon occurring during extrusion of thermoplastic polymers at the fabrication surface/polymer melt boundary. The occurrence of melt fracture produces severe surface irregularities in the extrudate as it emerges from the orifice. The naked eye detects this surface roughness in the melt-fractured sample as a frosty appearance or matte finish as opposed to an extrudate without melt fracture that appears clear.

Melt fracture occurs whenever the wall shear stress in the die exceeds a certain value (typically 0.1 to 0.2 MPa). The wall shear stress is controlled by the volume throughput or line speed (which dictates the shear rate) and the viscosity of the polymer melt. By reducing either the line speed or the viscosity at high shear rates, the wall shear stress is reduced lowering the possibility for melt fracture to occur. Thus, by increasing the degree of shear thinning, the viscosity is reduced at high shear rates, which then allows higher line speeds before melt fracture occurs.

The Ideal Polymer

Coupling all of these desired properties together, the ideal polymer from a processability standpoint will clearly have a high zero shear viscosity in conjunction with a high degree of shear thinning. This maximizes melt strength while at the same time minimizes melt fracture and die pressures. For injection molding, the low viscosity at high shear rates will allow the polymer to easily flow into the mold. However, once flow has stopped and the shearing removed, the polymer rapidly becomes highly viscous so that the part can be quickly removed from the mold. An analogous situation arises in paints, wherein one wants a fluid that easily flows or shear thins when brushed onto a surface, but does not run or drip after being applied, i.e. when the shear rate is lower. Pressure sensitive adhesives also require similar processability in that the adhesive should not flow and stick until pressure/stress is applied.

In contrast to the ideal polymer, condensation polymers like polycarbonates and polyesters have a very low degree of shear thinning relative to addition type polymers like PVC and polyolefins. This is because the condensation polymers typically have narrower molecular weight distributions in addition to lacking the high molecular weight “tail” common in many addition polymers. This narrow molecular weight distribution makes polyesters more “Newtonian-like” (i.e. having a flat viscosity which does not depend much on shear rate) and characteristically harder to process.

With respect to polyesters, either melt strength may be increased or melt fracture reduced without significantly affecting a change in the other. For example, by increasing the molecular weight or inherent viscosity of the polyester or by lowering the melt temperature, the zero shear viscosity will increase significantly along with the melt strength, but the degree of shear thinning will only change slightly. Thus, the melt strength will increase, but melt fracture will become even more of a problem since the high shear rate viscosity also increases significantly. In other words, the overall processability is not really improved. This may be acceptable for some applications. However, for applications like profile extrusion and injection molding where shear rates can be higher, both the melt strength and the melt fracture resistance must be improved simultaneously.

Chain branching is one of the most commonly used methods for improving the melt strength of a polymer, particularly polyesters. A tri-, tetra-, or higher functionality monomer is added to the polyester to create branches in the polymer, thus the polymer chain is no longer linear. Typical branching agents for polyesters include trimellitic anhydride (TMA), pyromellitic dianhydride (PMDA), glycerol, sorbitol, hexane triol-1,2,6, pentaerythritol, trimethylolethane, and trimesic acid. Common applications for high melt strength polyesters include extrusion blow molding and foams.

However, the use of branching agents alone result in an increase in the reaction rate, which if added at too high a level or not monitored properly can lead to unacceptable gel formation in the melt. A gel is nothing more than a point in the polyester where too much localized branching occurs, effectively creating a tightly interconnected network of chains that cannot be easily melted. This gel is present in the final molded/extruded part as an unacceptable visual defect. To minimize gelling, the branching agents are added at a low level with uniform dispersion throughout the reactor. Thus, a branched polyester is difficult to produce and the increase in melt strength is limited to the maximum amount of branching agent that can be added without gel formation.

To remedy gel formation, a monofunctional monomer can be added to the reactor in preparing the polyester. The monofunctional monomer has only one polyester reactive endgroup with either an acid or alcohol functionality. These monofunctional monomers are often referred to as either “endcappers” or chain terminators, because once they react with either a di-or higher functional monomer at the end of the polymer chain that particular chain growth is stopped. Examples of chain terminators commonly used include stearic acid and benzoic acid.

Chain terminators in stopping chain growth also serve to limit the maximum degree of polymerization (or IV) that can occur. In fact, this feature can be exploited in conjunction with higher functionality branching agents. Whereas a branching agent will serve to increase the degree and rate of polymerization, the chain terminator will tend to slow the reaction back down to a manageable level. This slowing down helps prevent branching agent-induced gel formation. However, the chain terminator in reducing the degree of polymerization also reduces the melt strength of the polymer. Since branching agents are often added to increase the melt strength, the addition of a chain terminator in conjunction with a branching agent might seem counterproductive. Thus, having an appropriate balance between the amount of branching agent and the amount of chain terminator added is important so that the desired melt strength is achieved without excessive gel formation.

Thus, there exists a need in the art to have a polyester composition with improved processability for extrusion and injection molding processes by simultaneously having a higher melt strength without gel formation and an increase in shear thinning. Accordingly, it is to the provision of such composition that the present invention is primarily directed.

### SUMMARY OF THE INVENTION

A polyester composition comprises a plurality of polar chain terminating groups at a concentration of 0.05 to 20 mole percent of a diacid component for structures (i) or (ii), a glycol component for structures (iii) or (iv), or mixtures thereof. The polar chain terminating groups have a structure selected from the group consisting of:

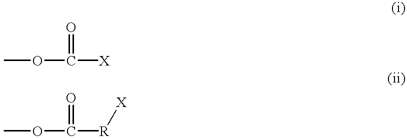

(iii) —O—R′—X

(iv) —O—R′″—R″—X

wherein X is a nonionic polar group or an ionic polar group neutralized with a counterion; R is an aromatic or aliphatic group; R′ is an aliphatic group; R″ is an aromatic group, and R′″ is an aliphatic group. The polyester composition is based on 100 mole percent of the diacid component and 100 mole percent of the glycol component.

### BRIEF DESCRIPTION OF THE DRAWINGS

FIG. 1 is a typical viscosity versus shear rate curve for a standard polyester and an “ideal” resin having improved processability.

FIG. 2 is an illustration of the formation of ionic clusters and branch points for a polyester composition of the present invention.

FIG. 3 is a viscosity (eta*) versus shear rate curve for the resins described in Example 1.

FIG. 4 is a viscosity versus shear rate curve for the resins described in Example 4.

FIG. 5 is a viscosity versus shear rate curve for the resins described in Example 5.

FIG. 6 is a viscosity versus shear rate curve for the resins described in Example 6.

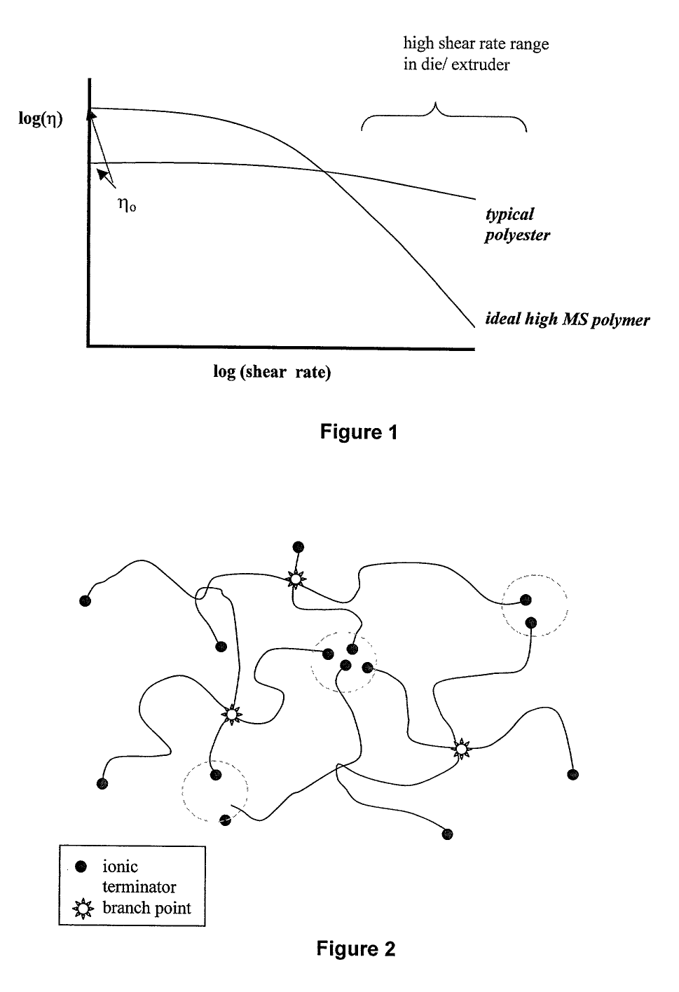

### DETAILED DESCRIPTION

The present invention is a polyester or copolyester, hereinafter collectively “polyester”, composition that is modified by the addition of a polar chain terminator that improves the processability of the polymer in processes such as injection molding, profile extrusion, film/sheet extrusion, calendering, and extrusion blow molding. The polar chain terminators tend to associate and form clusters with other polar endgroups on other chain ends. These clusters provide thermo-reversible crosslinks between polymer chains. This “pseudo-chain extension” synergistically acts to increase the melt strength and toughness of the polymer, thus making the polyester easier to process. This phenomenon is illustrated in FIG. 2.

In the present invention the polyester composition comprises a plurality of polar chain terminating groups at a concentration of 0.05 to 20 mole percent, preferably 0.05 to 10 mole percent, of a diacid component for structures (i) or (ii), a glycol component for structures (iii) or (iv), or mixtures thereof. The polar chain terminating groups may be selected from the following structures:

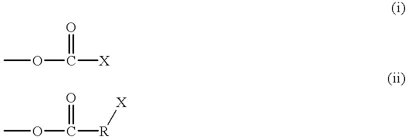

(iii) —O—R′—X, and

(iv) —O—R′″—R″—X;

wherein X is a nonionic polar group or an ionic polar group neutralized with a counterion; R is an aromatic or aliphatic group; R′ is an aliphatic group; R″ is an aromatic group, and R′″ is an aliphatic group. The polyester composition is based on 100 mole percent of the diacid component and 100 mole percent of the glycol component.

When X is the nonionic polar group, X is preferably an alcohol, a phosphine oxide, a phenol, a urea, a urethane, a carbonate, a polyethylene glycol, or a crown ether.

When X is the ionic polar group neutralized with a counterion, the ionic polar group is preferably a sulfonate, a phosphate, a phosphinate, a phosphonate. Examples of the ionic polar group include 3-sulfobenzoic acid, 2-sulfobenzoic acid, 4-sulfobenzoic acid, 3,5-disulfobenzoic acid, 2-bromo-5-sulfobenzoic acid, 2-hexadecyloxy-5-sulfobenzoic acid, 2-hexadecylthio-5-sulfobenzoic acid, and 4-[4-sulfophen-oxy-(4-phenoxy)]-benzoic acid. The counterion is preferably lithium, sodium, potassium, calcium, magnesium, cobalt, zinc, copper, manganese, iron, nickel, tin, titanium, or ammonium. Sodium is the preferred counterion because sodium is relatively inert and does not catalytically degrade the polymer.

The ionic polar group may also be a carboxylate that has an organic protective group attached thereto or has been added in excess. In such a case, the carboxylate is added to the polyester composition as a carboxylic acid. The free carboxylic acid hangs off of the chain end due to its polarity. Once the carboxylate is neutralized with a counterion, clusters form even though the polarity is lower than that of the highly polar neutralized sulfonate group. In a strict sense, the free hanging carboxylate group actually constitutes a second functional group. The carboxylate group is not a true chain terminator, which generally is monofunctional. Instead, the carboxylate groups are placed on the end of the chain by careful manipulation of the polymerization process. For example, an excess of terephthalic acid (or similar carboxylate group) is added to the reactor so that most of the chain ends are composed of acid groups instead of glycol ends. These acid ends can then be neutralized with the counterions.

The polar chain terminating groups may be derived from the following polar chain terminators: for structure (i) 4-hydroxybenzoic acid; for structure (ii) 2, 3, or 4-sodiosulfobenzoic acid; for structure (iii) 4-sodiosulfo-1-butanol; and for structure (iv) 2, 3, or 4-sodiosulfobenzyl alcohol.

In another aspect of the present invention, the polyester in addition to the polar chain terminating groups also contains a plurality of branching groups at a concentration of up to 2.0 mole percent. The branching groups are either acidic or alcoholic having tri- or greater polyester functionality. The acidic branching groups are a part of the diacid component of the polyester and the alcoholic branching groups are a part of the glycol component of the polyester. Examples of the branching groups derived from branching agents include trimellitic anhydride, trimellitic acid, pyromellitic dianhydride, glycerol, sorbitol, hexane triol-1,2,6, pentaerythritol, trimethylolethane, trimesic acid, or 1,3,5-tris-hydroxymethyl benzene. Preferably, the branching group is trimellitic anhydride (TMA). With TMA, concentrations of up to 1 mole percent, preferably 0.1 to 0.5 mole percent, are suitable for use in the invention.

When utilizing the polar chain terminating group and a tri-functional branching group, the ratio of terminating group to the branching agent is preferably less than 3:1, and more preferably the ratio is about 1:1. When utilizing the polar chain terminating group and a tetra-functional branching group, the ratio of terminating group to the branching agent is preferably less than 4:1, and more preferably the ratio is about 2:1.

In still another aspect of the invention, the polyester composition in addition to the polar chain terminating group may also contain a plurality of polar midchain difunctional groups at a concentration of up to 30 mole percent. The polar midchain difunctional group is a portion of the diacid component for structures (a) or (b), a portion of the glycol component for stuctures (d) or (e), or a portion of either diacid or glycol component for structure (c). Mixtures of any of the groups may be used as well. The branching groups may also be present if desired. The midchain difunctional groups may be selected from the following structures:

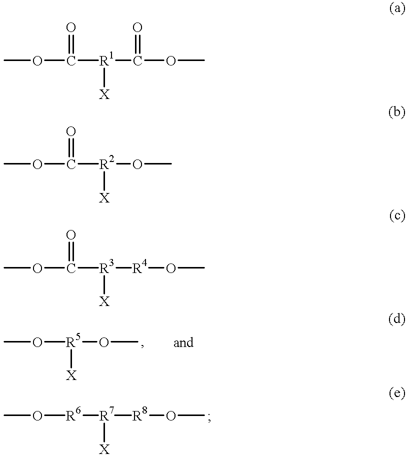

wherein X is a nonionic polar group or an ionic polar group neutralized with a counterion, R¹ is an aromatic or aliphatic group, R² is an aliphatic group, R³ is an aromatic group, R⁴ is an aliphatic group and R⁵ is an aliphatic group; R⁶ and R⁸ is an aliphatic group, and R⁷ is an aromatic group.

Examples of structures suitable for use to provide the polar midchain difunctional groups include for structure (a) 5-sodiosulfoisophthalic acid or 5(4-sodiosulfo phenoxy) isophthalic acid; for structure (b) 2-sodiosulfo-4-hydroxy butyric acid; for structure (c) 2-sodiosulfo-4-hydroxymethyl butyric acid; for structure (d) 2-hydroxyethyl-2-hydroxybutyl disodioethylphosphinate; and for structure (e) 2-sodiosulfohydroquinone.

In another embodiment of the invention, the polyester composition comprises:

(1) 100 to 48, preferably 100 to 58, mole percent of a diacid component comprising residues of a primary diacid selected from the group consisting of terephthalic acid, naphthalenedicarboxylic acid, isophthalic acid, adipic acid, and mixtures thereof;

(2) 100 to 48, preferably 100 to 58, mole percent of a glycol component comprising residues of a primary glycol selected from the group consisting of ethylene glycol (EG), 1,4-cyclohexanedimethanol (CHDM), diethylene glycol (DEG), 1,4-butanediol, neopentyl glycol (NPG), and mixtures thereof;

(3) 0.05 to 20, preferably 0.05 to 10, mole percent of residues of a polar chain terminator having a structure selected from the group consisting of:

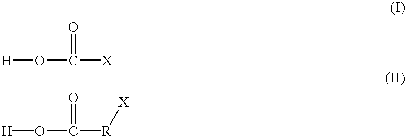

(III) H—O—R′—X

(IV) H—O—R′″—R″—X

or mixtures thereof;

wherein X is a nonionic polar group or an ionic polar group neutralized with a counterion; R is an aromatic or aliphatic group; R′ is an aliphatic group; R″ is an aromatic group, and R′″ is an aliphatic group;

(4) 0 to 2 mole percent of residues of a branching agent having a tri-functional or greater monomer, wherein the branching agent is acidic, alcoholic or a mixture thereof; and

(5) 0 to 30 mole percent of residues of a polar midchain difunctional monomer having a structure selected from the group consisting of:

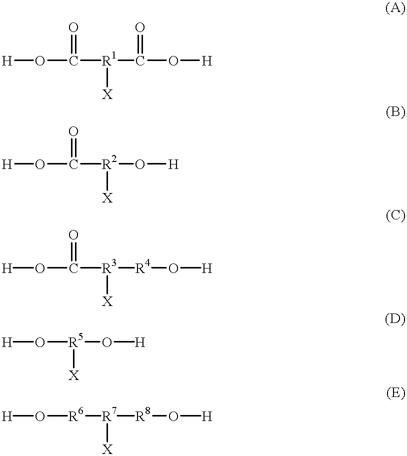

or mixtures thereof;

wherein X is a nonionic polar group or an ionic polar group neutralized with a counterion, R¹ is an aromatic or aliphatic group, R² is an aliphatic group, R³ is an aromatic group, R⁴ is an aliphatic group, R⁵ is an aliphatic group; R⁶ and R⁸ is an aliphatic group, and R⁷ is an aromatic group.

The polyester composition is based on 100 mole percent of a diacid component and 100 mole percent of a glycol component. Components (3), (4), and (5) form a portion of the diacid component, glycol component or both depending on whether the particular structure is acidic or alcoholic. Thus, at least one of the diacid or glycol components will be less than 100 mole percent depending on which of the polar chain terminators, acidic or alcoholic, is utilized. Preferably, the primary diacid is present from 99.95 to 58 mole percent and the polar chain terminator is acidic and present from 0.05 to 10 mole percent. Preferably, the primary glycol is present from 99.95 to 58 mole percent and the polar chain terminator is alcoholic and present from 0.05 to 10 mole percent.

In a preferred embodiment, the primary diacid comprises terephthalic acid (TPA) and up to 15 mole percent isophthalic acid. A more preferred embodiment is for the primary diacid to be solely TPA. When referring to the primary diacid component, the dimethyl ester thereof (e.g. dimethyl terephthalate instead of terephthalic acid) can also be used if an ester exchange process is utilized for manufacture instead of a straight esterification process.

The preferred primary glycol comprises EG, CHDM or a mixture thereof. When using NPG or DEG, preferably EG or CHDM are present. In such an embodiment, the preferred concentration for NPG is up to 40 mole percent and the preferred concentration for DEG is up to 40 mole percent, more preferably from up to 3 mole percent. In the most preferred embodiment, EG is the primary alcohol with from 10 to 35 mole percent CHDM and/or 25 to 40 mole percent NPG.

More detail for the polar chain terminator, branching agent and polar midchain difunctional monomer are discussed above with reference to the polar chain terminating group, branching group and polar midchain difunctional group, respectively.

Distinguishing between non-polar and polar chain terminators is an important aspect of the present invention. Chain terminators for polyesters have heretofore been non-polar in nature. Examples include stearic acid and benzoic acid. The use of the polar chain terminator, also identified above as the polar chain terminating group, in the present invention provides a primary benefit of forming clusters with other polar chain terminators in the polyester. This clustering is not as strong as a covalent bond, but still assists to further improve the rheological properties (e.g. melt strength) by effectively extending the chain length, particularly at lower temperatures. At higher processing temperatures these clusters reversibly break apart so that the polyester will more easily flow due to the reduced molecular weight of each chain. As the polyester is cooled, the clusters reform effectively increasing the average chain length and thereby increasing the viscosity and melt strength of the polyester. Thus, the polyester of the present invention flows easily through the die at high temperatures, but rapidly “sets-up” as the polyester cools, thereby improving the overall moldability/processability. In other words, the polar chain terminating modified polyesters have higher thermal activation energy and, as such, will decrease in viscosity more quickly with increasing temperature.

A secondary, albeit important benefit of using polar as opposed to non-polar chain terminators is that polar chain terminators are often less volatile. Many of the non-polar chain terminators for polyesters, such as stearic acid and benzoic acid, are so volatile that they are difficult to maintain in the reactor during polymerization. The use of the volatile non-polar chain terminator with a branching agent makes stoichiometric control of the branching agent/chain terminator ratio very difficult such that melt strength and gel formation are much harder to control. In contrast, one of the ionic polar chain terminator of the present invention, i.e. 3-sodiosulfobenzoic acid, is a salt and as such does not easily boil out of the reactor thereby making stoichiometric control of the branching agent/chain terminator ratio much easier.

The use of polar chain terminators in the polyester can also be used to improve or modify other properties of the polymer. For example, the modified polyester may have improved solvent resistance, enhance printability, and improved flame retardancy.

When the polyester composition optionally contains the tri-, tetra- or higher functionality branching agent. The branching agent, also identified above as the branching group, imparts a higher melt strength and a greater degree of shear thinning when compared to not using the branching agent. Thus, the polyester is easier to extrude/injection mold in conventional polymer processing equipment. The polar chain terminator further increases the “processability” by way of the thermo-reversible crosslinks. The use of the polar chain terminator also provides a secondary benefit, which is to offset the formation of gels common in branched polyester systems by controlling the polymerization reaction rate and preventing runaway reactions. Thus, using a polar chain terminator allows for a higher level of branching agent in the polyester composition. The resulting polyester composition has significantly improved processability by having an even higher melt strength and even greater degree of shear thinning. Furthermore, polar midchain difunctional groups are optionally added along the polymer backbone to further enhance the clustering, thus leading to even more improvement in processability.

The level of branching agent, polar chain terminator, or polar midchain difunctional monomer can vary depending on how much Theological modification is desired. Typically, polar association becomes significant when the polar groups are present above about 1 to 2 mole percent either at the chain ends or along the backbone. Full cluster formation becomes significant at when the polar groups are present above about 5 to 10 mole percent. Of course, this depends on the given polyester composition.

In order to control the reaction rate and prevent gel formation, preferably the molar ratio of polar chain terminator to branching agent is about 1:1 for a tri-functional branching agent such as TMA or about 2:1 for a tetra-functional branching agent such as PMDA. This ratio ensures that the theoretical average functionality of the system remains at 2 or difunctional, thereby eliminating gel formation. Higher ratios of polar chain terminator to branching agent can be used without gel formation. However, this reduces the final IV of the system, which in turn reduces the melt strength. For polymers that are subjected to solid state polymerization in addition to melt phase polymerization (e.g. bottle grade polyethylene terephthalate), the propensity for gel formation is even higher. Thus, the ratio of the polar chain terminator to the branching agent is recommended to be slightly higher than for solely melt-phase polymers. Preferably, that ratio is between about 1.1:1 to about 1.6:1 for a tri-functional branching agent and between about 2.1:1 to about 3:1 for a tetra-functional branching agent.

Preferred levels of polar chain terminators and branching agents depend on the particular end-use application. Four main categories include as follows:

I. The branching agent and polar chain terminator are present at levels less than about 0.5 mole percent to provide light to moderate processability improvement. Typically the ratio of polar chain terminator to branching agent will be less than 2:1, preferably about 1:1. At these lower levels, the branching agent provides the bulk of the processability improvement, whereas the polar chain terminator functions more as a non-volatile chain terminator for preventing gel formation. This formulation is adequate for most applications requiring only a slight to moderate increase in processability over the conventional polyester.

II. Branching agents are present at levels from 0.5 to about 2 mole percent with the polar chain terminator to branching agent ratio being less than 2:1, preferably about 1:1. At these higher levels, the polar chain terminator associations become significant. These resins have even better processability than Category I. However, these resins are often more difficult to manufacture due to the difficulties in maintaining proper dispersion of the branching agent. Even higher levels of branching agent (greater than 2%) can be used, but the difficulties associated with their manufacture often outweigh the benefits.

III. The polyester composition incorporates polar functionality along the main chain through use of the polar midchain difunctional monomer. The branching agent is preferably present from 0.1 to 1 mole percent. The polar chain terminator is preferably present from 0.1 to 4 mole percent when used with a tetra-functional branching agent and 0.1 to 3 mole percent when used with a tri-functional branching agent. A preferred range for this polar midchain difunctional monomer is 0 to 30 mole percent. A more preferred range is 2 to 15 mole percent. This polar midchain difunctional monomer for the achievement of significant levels of polar clustering without affecting the overall molecular weight of the chain.

IV. The polyester composition contains significant levels of the polar chain terminators (with or without the polar midchain difunctional monomer), but no branching agents. Typical ranges of polar chain terminator are from 1 to 10 mole percent, preferably about 5 mole percent. The polar chain terminator will form the reversible crosslinks with itself or optionally with the polar midchain difunctional monomer. However, the overall molecular weight of the system will be lower and thus also the viscosity and melt strength. This loss of viscosity can be extremely useful for injection molding applications. The overall viscosity will be significantly lower at processing temperatures due to the breakup of the polar clusters and the lower chain molecular weight, thereby lowering the required fill pressures. In order to get the polar clustering up to a significant level, the polar midchain difunctional monomer can be added. The resulting clusters will further anchor the polar chain terminators and increase the processability.

Regardless of the formulation, when preparing the polyester composition, the acid-based branching agents are preferably pre-reacted with the glycol before adding to the reactor. This evenly distributes the branching agent, reduces the amount of residual branching agent in the final product, and minimizes the amount of related extractables.

Alternately, the branching agent and polar chain terminator are added in the form of a concentrate or masterbatch that is dry blended with the neat polyester of the primary diacid and primary glycol just before entering the extruder or injection molder. Also, an appropriate feeder can be used to add the concentrate to the extruder. The level of branching agent in the concentrate would have to be much higher (greater than 0.5 mole percent) with the exact level depending on the masterbatch “letdown” ratio. Because of the higher level of branching agent in the concentrate, reaction conditions have to be more carefully controlled to prevent gelling. However, this approach may not achieve the same broad molecular weight distribution (thus reducing its effectiveness) compared to a reactor grade product if sufficient trans-esterification does not occur in the extruder.

Another proposed method for incorporation of the branching agent and polar chain terminator in the correct stoichiometric balance is to form an intermediate ester (e.g. glycerol monosodiosulfobenzoate) and add this to the extruder. The ester would break apart upon heating thereby releasing the glycerol (branching agent) and the sodio-sulfobenzoic acid (polar chain terminator), so that the two could react into the polymer in the extruder barrel. Many processing aids (e.g. pentaerythritol tetrastearate) already take this ester form.

This invention can be further illustrated by the following examples of preferred embodiments thereof, although it will be understood that these examples are included merely for purposes of illustration and are not intended to limit the scope of the invention unless otherwise specifically indicated.

### EXAMPLES

### Example 1

This example demonstrates modification of PETG copolyesters with ionic chain terminators and branching agents.

A series of copolyesters were made to investigate the effects low level ionic modification and branching on rheological properties. The base resin was PETG, a copolyester made from a diacid component of 100 mole percent terephthalic acid and a glycol component of 69 mole percent ethylene glycol (EG) and 31 mole percent 1,4-cyclohexanedimethanol (CHDM). Samples were made in 30-pound (136 kg) batches. The branching agent, trimellitic anhydride (TMA), was added to the reactor in the form of a pre-reacted slurry with ethylene glycol in order to ensure full reactivity. The ionic chain terminator, 3-sodiosulfobenzoic acid (SSBA), was charged to the reactor with the rest of the constituents. A 1:1 ratio of chain terminator and branching agent was maintained for all resins except for #2, which had no SSBA.

The “control” resin was the PETG base resin having an IV of 0.76 dl/g and containing no ionic chain terminator or branching agent. The “branched control” was the PETG base resin having an IV of 0.76 dl/g, containing 0.15 mole percent TMA and containing no ionic chain terminator. Higher levels of branched only PETG were not utilized in this example because of difficulty in making due to very high polymerization rates and gel formation. The resins (R) are listed in Table I along with compositional and molecular weight (GPC) data. There are two IV levels for each of the SSBA modifications.

As observed, the branching and ionic endcapping served to increase Mw and Mz while decreasing Mn slightly. The IV also played an important role. This causes an overall increase in the breadth of the molecular weight distribution (Mw/Mn). The increase in Mz and molecular weight distribution normally correlates with an increase in die swell, melt strength and shear thinning as observed in the following resins examples.

TABLE II

| | | IV | Mn | Mw | Mz | Mw/ |
|---|---|---|---|---|---|---|
| R# | Description of Polyester | dl/g | G/mol | g/mol | g/mol | Mn |
| 1 | PETG Control | 0.76 | 13333 | 38346 | 61943 | 2.87 |
| 2 | PETG Branched Control | 0.76 | 12562 | 43376 | 81160 | 3.45 |
| | with 0.15 mole % TMA | | | | | |
| 3 | PETG + 0.2 mole % | 0.69 | 12100 | 38300 | 68500 | 3.16 |
| | and 0.2 mole % | | | | | |
| | SSBA | | | | | |
| 4 | PETG + 0.2 mole % | 0.73 | 11726 | 43140 | 91451 | 3.67 |
| | TMA and 0.2 mole % | | | | | |
| | SSBA | | | | | |
| 5 | PETG + 0.5 mole % | 0.69 | 10757 | 38300 | 79666 | 3.56 |
| | TMA and 0.5 mole % | | | | | |
| | SSBA | | | | | |
| 6 | PETG + 0.5 mole % | 0.75 | 11434 | 44983 | 99910 | 3.93 |
| | TMA and 0.5 mole % | | | | | |
| | SSBA | | | | | |

### Example 2

This example measures rheological and melt strength data for the modified PETG copolyesters of Example 1.

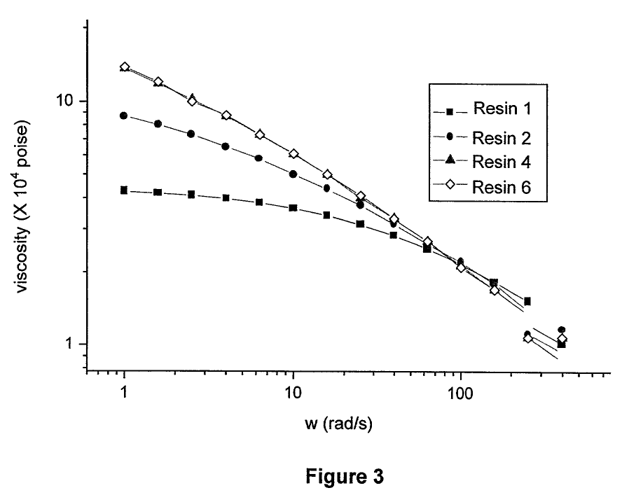

Viscosity data for resin #s 1, 2, 4 and 6 in Table I were obtained using a cone and plate rheometer at 220° C. The data is displayed in FIG. 3. As observed, the resins with branching agent and ionic chain terminator had a significant degree of shear thinning (i.e. low shear viscosity) and greater melt strength. This was true even though the IV of the SSBA modified resins were actually slightly lower than the control resins.

Die swell (DS) and melt strength (MS) data were obtained at 220° C. using a capillary rheometer (see earlier description of method in the text). These values are tabulated in Table II. For the higher IV SSBA modified resins (#5 and #6), the die swell and melt strength were significantly larger than either the PETG control (#1) or the PETG branched control (#2). In fact, the higher IV SSBA modified resins have melt strengths comparable to or larger than competitive resins like PVC.

TABLE II

| R# | Description of Polyester | IV dl/g | DS, % | MS, % |
|---|---|---|---|---|
| 1 | PETG Control | 0.76 | 5 | −26 |
| 2 | PETG Branched Control | 0.76 | 30 | 4 |
| | with 0.15 mole % TMA | | | |
| 3 | PETG + 0.2 mole % TMA | 0.69 | 24 | 4 |
| | and 0.2 mole % SSBA | | | |
| 4 | PETG + 0.2 mole % TMA | 0.73 | 41 | 22 |
| | and 0.2 mole % SSBA | | | |
| 5 | PETG + 0.5 mole % TMA | 0.69 | 30 | 5 |
| | and 0.5 mole % SSBA | | | |
| 6 | PETG + 0.5 mole % TMA | 0.75 | 55 | 41 |
| | and 0.5 mole % SSBA | | | |

### Example 3

This example compares the processing characteristics for the modified PETG copolyesters of Example 1.

Samples of resins #1 to #6 were extruded on a 1″ (2.5 cm) Killion extruder equipped with a 6-inch (15 cm) film die. All barrel heaters were set to 240° C. and the screw RPM held constant. The amperage on the screw and the die pressure were recorded for each resin and compiled in Table III. These numbers provide an indication of the viscosity and degree of shear thinning occurring in the extruder barrel and die. High motor loads mean excessive energy consumption, which can lead to higher processing costs.

In comparing the data in Table III, the lower IV SSBA modified resins (#3 and #5) had much lower die pressures and screw amperage, even though their melt strength and die swell were higher than that of the control (#1) or branched control (#2) resins (see Table II). Thus, resins #3 and #5 were easier to process in the extruder and easier to handle in melt form once the resins exited the extruder. The higher IV SSBA modified resins #4 and #6 had comparable screw amperage to the control #1, although their melt strengths were significantly higher. Similarly, the die pressures of resins #4 and #5, while higher than the control, were comparable to that of resin #2. Whereas, the screw amperages were slightly lower.

Also listed in Table III are the sag time numbers. This is a relative estimate of the melt strength obtained by measuring the time that the extruded polymer falls from the die to the floor. The die was set at an arbitrary distance of 40 inches (100 cm) above the floor and the die scraped clean at time zero. A longer sag time means greater melt strength. A comparison of Table II and III illustrates as expected that the sag time and the true melt strength follow similar trends. The sag times in Table III further illustrate the greater melt strength of the SSBA/branched resins.

TABLE III

| R# | Die Pressure (psi) | Screw Amperage | Sag Time (s) |
|---|---|---|---|
| 1 | 1380 | 10 | 18.4 |
| 2 | 1800 | 10.3 | 45 |
| 3 | 1300 | 8.3 | 22.5 |
| 4 | 1640 | 7.5 | 50 |
| 5 | 1300 | 6.1 | 32 |
| 6 | 1940 | 10 | 63 |

### Example 4

This example demonstrates injection molding effects of the modified polyesters of the present invention.

Four polyethylene terephthalate (PET) polyesters were made to determine the effects of ionic modification on cycle times in injection molding processes. All resins contained 0.25 mole percent of TMA as the branching agent (except for the PET control) and had varying levels of 3-sodiosulfobenzoic acid added as the polar chain terminator. All resins were prepared using standard polyester conditions for melt phase processes up to an IV of approximately 0.57 dl/g. Following the melt phase step, the polymers were pelletized and crystallized, and then solid-state polymerized at 215° C. Final target IV was approximately 0.74 to 0.76 dl/g, although this target was not reached for all of the samples tested. Solid stating time varied from 16 to 32 hours depending on the rate of IV buildup. A commercial PET (PET 9921 Polyester available from Eastman Chemical Company, Kingsport, Tenn.) having an IV of 0.76 dl/g was used as the control. Resins with much higher levels of ionic chain terminator (e.g. #9 and #10) were not able to reach the target IV due to the encapping effect. The results are listed in Table IV.

To determine cycle time, the resins were injection molded on a Boy 22 molding machine, using a single cavity, 20 oz. (566 grams), preform mold. Melt and barrel temperatures were nominally 290° C. The injection shot was set up to have a high fill rate, but with both the low and high pressure injection stages limited to a maximum pressure of 500 psi (3.45 MPa). Thus, the cycle was pressure limited so that resin processability differences could be easier to quantify. The time for the screw to completely ram forward and fill the mold was measured using a stop watch and is listed in Table IV. Shorter mold filling times imply faster cycles. The presence of gels was also noted.

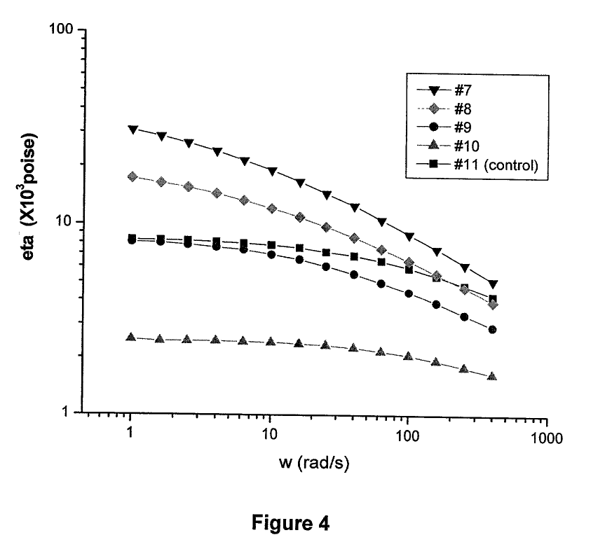

As indicated, all but resin #7 had a faster cycle time than the control. Resin #7 had both significant gels and a much higher IV due to overshoot on the solid stating. This is because the branching agent coupled with a lower level of polar chain terminator resulted in a much faster solid-stating rate. The reason for the higher cycle time is also illustrated in FIG. 4, in which resin #7 has a higher viscosity over the whole shear rate range. If resin #7 had been at the 0.76 IV, a cycle time lower than the control resin #11 (due to lower viscosity) would have been expected and much fewer gels.

All of the remaining resins had lower cycle time than the control, which is supported by the viscosity curves of FIG. 4 measured at 280° C. Injection molding involves shear rates from 100 to 1000 1/s in the body and in excess of 1000 1/s in the gate area. Even resin #8, which had a higher, low-shear viscosity (i.e. greater melt strength), could be molded faster due to the high degree of shear thinning.

This example also illustrates the importance of polar chain terminator to brancher ratio to prevent gelling. Ratios in this experiment ranged from 1.4:1 to 3:1. To eliminate gels and still maintain melt strength, a ratio of approximately 1:5:1 is preferred (e.g. #8 or #9).

TABLE IV

| | | IV, | | Injection |
|---|---|---|---|---|
| R# | Description of Polyester | dl/g | gels? | Time, s |
| 7 | PET + 0.25 mole % TMA + | 0.83 | moderate | 2.42 |
| | 0.35 mole % 3-SSBA | | | |
| 8 | PET + 0.25 mole % TMA + | 0.74 | light | 1.33 |
| | 0.40 mole % 3-SSBA | | | |
| 9 | PET + 0.25 mole % TMA + | 0.68 | no | 1.15 |
| | 0.50 mole % 3-SSBA | | | |
| 10 | PET + 0.25 mole % TMA + | 0.61 | no | 0.68 |
| | 0.75 mole % 3-SSBA | | | |
| 11 | PET 9921 Control | 0.76 | no | 1.70 |

### Example 5

This example demonstrates modification of aliphatic-aromatic copolyesters with polar chain terminators and branching agents.

A commercial aliphatic-aromatic copolyester (Eastar BioCopolyester 14766 available from Eastman Chemical Company) used for biodegradable film applications was compared with a similar composition having been modified with a branching agent and a polar chain terminator. The commercial resin is denoted as resin #12 and had an IV of 1.05 dl/g and a glass transition temperature (Tg) of −27° F. (−33° C.). Resin #13 had 0.5 mole % TMA branching agent and 0.5 mole % of 3-sodiosulfobenzoic acid resulting in a pellet IV of 1.01 dl/g.

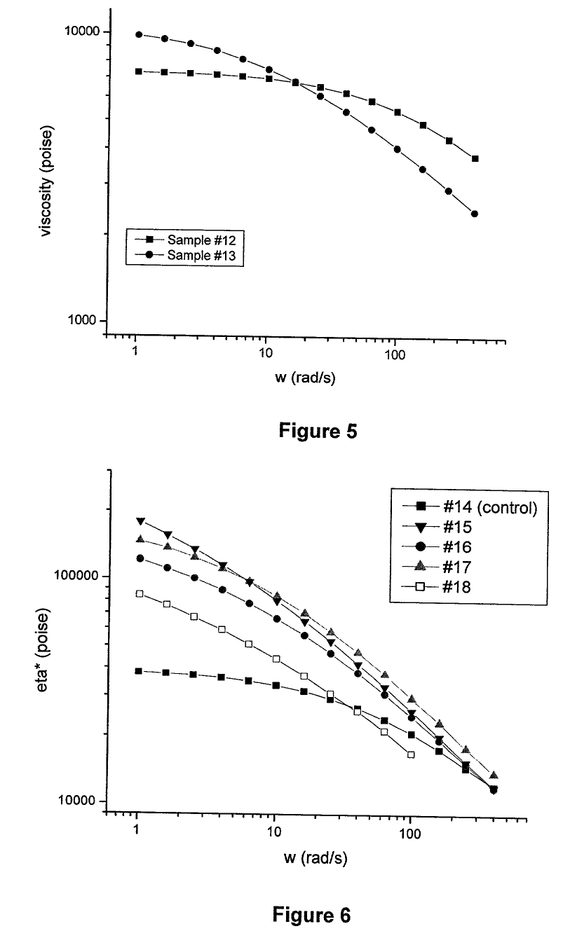

Even with the lower IV, #13 had improved processability as illustrated in FIG. 5. When processed on a blown film line, #13 was easier to start up due to the higher melt strength and maintained a much more stable film bubble.

### Example 6

This example demonstrates modification of PETG copolyesters with polar chain terminator, polar midchain difunctional monomer, and branching agent.

Samples of PETG copolyester were made containing both polar chain terminator and polar midchain difunctional monomer. The base polymer was the same copolyester as that of Example 1. The control was the unmodified PETG copolyester (Resin #14). The branching agent was 0.5 mole % TMA and the polar chain terminator was 0.5 mole % 3-sodiosulfobenzoic acid. The polar midchain difunctional monomer of 5-sodiosulfoisophtalic acid (5-SSIPA) was randomly distributed. Resins #15-17 had 1, 2, and 5 mole % of the 5-SSIPA, respectively. The IV for these samples were 0.71, 0.59 and 0.46 dl/g respectively with the decreasing IV being a consequence of increased melt viscosity in the reactor limiting the extent of reaction. Resin #18 has 0.5% TMA and 0.5% 3-sodiosulfobenzoic acid, but no 5-SSIPA, with an IV of 0.70 dl/g.

Graphs of the viscosity versus frequency at 220° C. were compiled in FIG. 6. For comparable IV, the 5-SSIPA has the effect of increasing the overall viscosity of the film as compare to resins #14 and #18. Regardless, the resins containing the polar chain terminator all have greater processability than the control resin with or without the 5-SSIPA present. The 1% loading of 5-SSIPA (#15) seemed to have the greatest degree of shear thinning of all of the examples

### Example 7

This example demonstrates the synthetic procedure for preparing carboxyl-terminated polyesters utilizing terephthalic acid modification.

A 500 ml round bottom flask equipped with a ground glass head, agitator shaft, and a nitrogen inlet/outlet was charged with 96 grams of polyethylene terephthalate and 0.415 grams (0.0025 moles) of terephthalic acid. The flask was purged with nitrogen and immersed in a Belmont metal bath at 140° C. under a slow sweep of nitrogen with sufficient agitation. The pressure was reduced from 760 mm Hg to 0.5 mm Hg over the course of 2 minutes and held for an additional 60 minutes. The vacuum was then displaced with a nitrogen atmosphere over the course of two minutes. The temperature was then subsequently raised from 140° C. to 275° C. over the course of 20 minutes and held for an additional 30 minutes. The pressure was then reduced from 760 mm Hg to 0.5 mm Hg over a period of 10 minutes and held for an additional 90 minutes. The vacuum was displaced with a nitrogen atmosphere and the clear polymer was allowed to cool and crystallize before removal from the flask. An inherent viscosity of 0.56 dL/g was determined for the recovered polymer according to ASTM D3835-79. Potentiometric titrations indicated that the carboxyl endgroup concentration was 73.02 equivalents/10⁶ grams of polymer.

### Example 8

This example is comparative with respect to Examples 7 and 9.

The apparatus in Example 7 was charged with 96 grams of polyethylene terephthalate and treated to the same heat/pressure cycles as Example 7. An inherent viscosity of 0.735 dL/g was determined for the recovered polymer according to ASTM D3835-79. Potentiometric titrations indicated that the carboxyl endgroup concentration was 36.11 equivalents/10⁶ grams of polymer.

### Example 9

This example demonstrates the synthetic procedure for preparing carboxyl-terminated polyesters utilizing phthalic anhydride modification.

The apparatus in Example 7 was charged with 40 grams of polyethylene terephthalate and 0.5 grams (0.0034 moles) of phthalic anhydride. The flask was purged with nitrogen and immersed in a Belmont metal bath at 140° C. under a slow sweep of nitrogen with sufficient agitation. The temperature was raised from 140° C. to 275° C. over a period of 20 minutes and held for an additional 30 minutes. The pressure was then reduced from 760 mm Hg to 0.3 mm Hg over a period of 10 minutes and held for an additional 60 minutes. The vacuum was displaced with a nitrogen atmosphere and the clear polymer was allowed to cool and crystallize before removal from the flask. An inherent viscosity of 0.52 dL/g was determined for the recovered polymer according to ASTM D3835-79. Potentiometric titrations indicated that the carboxyl endgroup concentration was 71.88 equivalents/10⁶ grams of polymer.

### Example 10

This example demonstrates modification of copolyesters that contain terephthalic acid, isophthalic acid and 1,4-cyclohexanedimethanol (PCTA copolyesters) with polar chain terminators and branching agents.

A PCTA based formulation was prepared from a diacid component consisting of 73 mole percent terephthalic acid, 26 mole percent isophthalic acid, 0.5 mole percent trimellitic anhydride and 0.5 mole percent of 3-sodiosufobenzoic acid. The glycol component of this formulation is 100 mole percent 1,4-cyclohexanedimethanol (except for a small amount of EG added with the TMA).

A 60 pound batch was prepared by charging a batch reactor with 14.06 kg of dimethyl terephthalate, 5.0 kg of dimethyl isophthalate, 238.67 grams of a 39.99% prereacted solution of trimellitic anhydride in ethylene glycol, 111.1 grams of 3-sodiosulfo benzoic acid and 24.3 kg of 1,4-cyclohexanedimethanol. The reaction was catalyzed by the addition of 53.41 grams of a 2.55% solution of titanium in butanol.

The reaction mixture was heated to 270° C. over about 3 hours. When the temperature was reached, the pressure was reduced at 13 mm/min to a pressure of less than 1 mm. The torque on the agitator was monitored to determine the end point. The pressure was then returned to normal atmospheric pressure and the material was extruded and palletized for later use.

As expected, this material shows increased performance in profile extrusion applications. The material had increased low shear viscosity and significant shear thinning compared to comparable materials without the addition of branching agents and ionic chain terminators.

The invention has been described in detail with particular reference to preferred embodiments thereof, but it will be understood that variations and modifications can be effected within the spirit and scope of the invention.

We claim:

1. A polyester composition comprising a plurality of polar chain terminating groups at a concentration of 0.05 to 20 mole percent having a structure selected from the group consisting of: 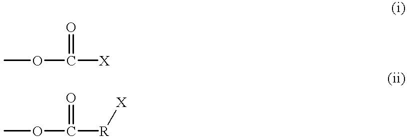
(iii) —O—R′—X
(iv) —O—R′″—R″—X
or mixtures thereof,
wherein X is a nonionic polar group or an ionic polar group neutralized with a counterion; R is an aromatic or aliphatic group; R′ is an aliphatic group; R″ is an aromatic group, and R′″ is an aliphatic group and wherein the polyester composition is based on 100 mole percent of a diacid component and 100 mole percent of a glycol component and the mole percent of the polar chain terminating groups is a portion of the diacid component for structures (i) and (ii) and a portion of the glycol component for structures (iii) and (iv).

2. The polyester composition of claim 1 wherein the polar chain terminating groups are present from 0.05 to 10 mole percent.

3. The polyester composition of claim 1 wherein X is the nonionic polar group selected from the group consisting of an alcohol, a phosphine oxide, a phenol, a urea, a urethane, a carbonate, a polyethylene glycol, and a crown ether.

4. The polyester composition of claim 1 wherein X is the ionic polar group neutralized with a counterion and the ionic polar group is selected from the group consisting of a sulfonate, a phosphate, a phosphinate, and a phosphonate.

5. The polyester composition of claim 1 wherein X is the ionic polar group neutralized with a counterion and the ionic polar group is a carboxylate having an organic protective group attached thereto or having been added in excess.

6. The polyester composition of claim 1 wherein X is the ionic polar group neutralized with the counterion and the ionic polar group is selected from the group consisting of 3-sulfobenzoic acid, 2-sulfobenzoic acid, 4-sulfobenzoic acid, 3,5-disulfobenzoic acid, 2-bromo-5-sulfobenzoic acid, 2-hexadecyloxy-5-sulfobenzoic acid, 2-hexadecylthio-5-sulfobenzoic acid, and 4-[4-sulfophenoxy-(4-phenoxy)]-benzoic acid.

7. The polyester composition of claim 1 wherein X is the ionic polar group neutralized with the counterion and the counterion is selected from the group consisting of lithium, sodium, potassium, calcium, magnesium, cobalt, zinc, copper, manganese, iron, nickel, tin, titanium, and ammonium.

8. The polyester composition of claim 1 wherein the polar chain terminating group of the structure (i) is derived from 4-hydroxybenzoic acid.

9. The polyester composition in claim 1 wherein the polar chain terminating group of the structure (ii) is derived from 2, 3 or 4-sodiosulfobenzoic acid.

10. The polyester composition of claim 1 wherein the polar chain terminating group of the structure (iii) is derived from 4-sodiosulfo-1-butanol.

11. The polyester composition of claim 1 wherein the polar chain terminating group of the structure (iv) is derived from 2, 3, or 4-sodiosulfobenzyl alcohol.

12. The polyester of claim 1 further comprising a plurality of branching groups, wherein up to 2.0 mole percent of the branching groups are acidic having tri- or greater functionality and up to 2.0 mole percent of the branching groups are alcoholic having tri- or greater functionality.

13. The polyester of claim 12 wherein the branching group is selected from the group consisting of trimellitic anhydride, trimellitic acid, pyromellitic dianhydride, glycerol, sorbitol, hexane triol-1,2,6, pentaerythritol, trimethylolethane, trimesic acid, and 1,3,5-tris-hydroxymethyl benzene.

14. The polyester composition of claim 13 wherein the branching group is trimellitic anhydride.

15. The polyester composition of claim 14 wherein the trimellitic anhydride is present up to 1 mole percent.

16. The polyester composition of claim 15 wherein the trimellitic anhydride is present between 0.10 and 0.5 mole percent.

17. The polyester composition of claim 12 wherein the branching group is tri-functional and the polar chain terminating group and the tri-functional branching group are present at a ratio of less than 3:1.

18. The polyester composition of claim 17 wherein the polar chain terminating group and the tri-functional branching group are present at a ratio of about 1:1.

19. The polyester composition of claim 17 wherein the polyester is solid state polymerized and the polar chain terminating group and the tri-functional branching group are present at a ratio of between about 1.1:1 to about 1.6:1.

20. The polyester composition of claim 12 wherein the branching group is tetra-functional, and the polar chain terminating group and the tetra-functional branching group are present at a ratio of less than 4:1.

21. The polyester composition of claim 20 wherein the polar chain terminating group and the tetra-functional branching group are present at a ratio of about 2:1.

22. The polyester composition of claim 20 wherein the polyester is solid state polymerized and the polar chain terminating group and the tetra-functional branching group are present at a ratio of between about 2.1:1 to about 3:1.

23. The polyester of claim 1 further comprising a plurality of polar midchain difunctional groups, wherein up to 30 mole percent of the midchain difunctional groups have a structure selected from the group consisting of: 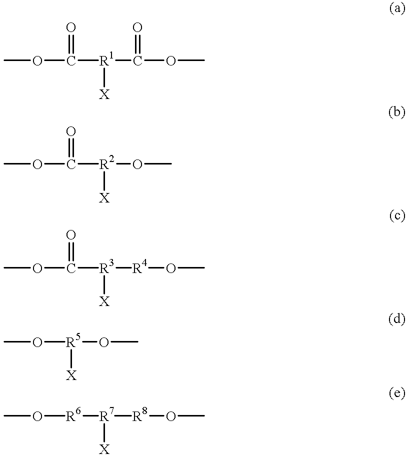
or mixtures thereof;
wherein X is a nonionic polar group or an ionic polar group neutralized with a counterion, R′ is an aromatic or aliphatic group, R² is an aliphatic group, R³ is an aromatic group, R⁴ is an aliphatic group and R⁵ is an aliphatic group; R⁶ and R⁸ is an aliphatic group, and R⁷ is an aromatic group and wherein the mole percent of the polar midchain difunctional groups is a portion of the diacid component for structures (a) and (b), a portion of the glycol component for structures (d) and (e) and a portion of either the diacid component or the glycol component for structure (c).

24. The polyester composition of claim 23 wherein the polar midchain difunctional group of structure (a) is derived from 5-sodiosulfoisophthalic acid or 5(4-sodiosulfo phenoxy) isophthalic acid.

25. The polyester composition of claim 23 wherein the polar midchain difunctional group of structure (b) is derived from 2-sodiosulfo-4-hydroxy butyric acid.

26. The polyester composition of claim 23 wherein the polar midchain difunctional group of structure (c) is derived from 2-sodiosulfo-4-hydroxymethyl butyric acid.

27. The polyester composition of claim 23 wherein the polar midchain difunctional group of structure (d) is derived from 2-hydroxyethyl-2-hydroxybutyl disodioethylphosphinate.

28. The polyester composition of claim 23 wherein the polar midchain difunctional group of structure (e) is derived from 2-sodiosulfohydroquinone.

29. The polyester of claim 23 further comprising a plurality of branching groups, wherein up to 2.0 mole percent of the branching groups are acidic having tri- or greater functionality and up to 2.0 mole percent of the branching groups are alcoholic having tri- or greater functionality.

30. A polyester composition comprising
(1) 100 to 48.0 mole percent of a diacid component comprising residues of a primary diacid selected from the group consisting of terephthalic acid, naphthalenedicarboxylic acid, isophthalic acid, adipic acid, and mixtures thereof;
(2) 100 to 48.0 mole percent of a glycol component comprising residues of a primary glycol selected from the group consisting of ethylene glycol, 1,4-cyclohexanedimethanol, diethylene glycol, 1,4-butanediol, neopentyl glycol, and mixtures thereof
(3) 0.05 to 20 mole percent of residues of a polar chain terminator having a structure selected from the group consisting of: 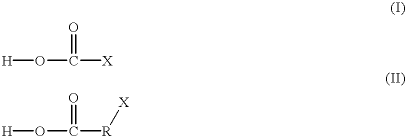
(III) H—O—R′—X
(IV) H—O—R′″—R″—X
or mixtures thereof;
wherein X is a nonionic polar group or an ionic polar group neutralized with a counterion; R is an aromatic or aliphatic group; R′ is an aliphatic group; R″ is an aromatic group, and R′″ is an aliphatic group;
(4) 0 to 2.0 mole percent of residues of a branching agent having a tri-functional or greater monomer, wherein the branching agent is acidic, alcoholic or a mixture thereof and the acidic branching agent is a portion of the diacid component and the alcoholic branching agent is a portion of the glycol component; and
(5) 0 to 30 mole percent of residues of a polar midchain difunctional monomer having a structure selected from the group consisting of: 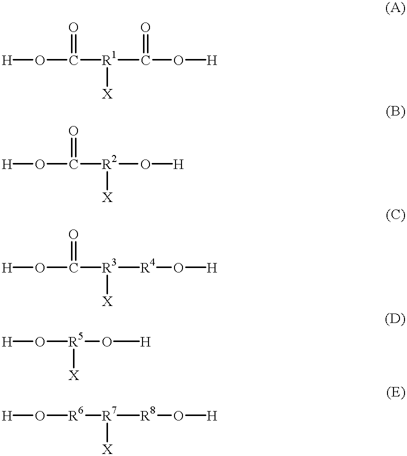
or mixtures thereof;
wherein X is a nonionic polar group or an ionic polar group neutralized with a counterion, R¹ is an aromatic or aliphatic group, R² is an aliphatic group, R³ is an aromatic group, R⁴ is an aliphatic group, R⁵ is an aliphatic group; R⁶ and R⁸ is an aliphatic group, and R⁷ is an aromatic group;
wherein the polyester composition is based on 100 mole percent of a diacid component and 100 mole percent of a glycol component; the mole percent of the polar chain terminating groups is a portion of the diacid component for structures (I) and (II) and a portion of the glycol component for structures (III) and (IV); and the mole percent of the polar midchain difunctional groups is a portion of the diacid component for structures (A) and (B), a portion of the glycol component for structures (D) and (E) and a portion of either the diacid component or the glycol component for structure (C).

31. The polyester composition of claim 30 wherein the primary diacid is present from 99.95 to 58 mole percent and the polar chain terminator is acidic and present from 0.05 to 10 mole percent.

32. The polyester composition of claim 30 wherein the primary glycol is present from 99.95 to 58 mole percent and the polar chain terminator is alcoholic and present from 0.05 to 10 mole percent.

33. The polyester composition of claim 30 wherein X is the nonionic polar group selected from the group consisting of an alcohol, a phosphine oxide, a phenol, a urea, a urethane, a carbonate, a polyethylene glycol, or a crown ether.

34. The polyester composition of claim 30 wherein X is the ionic polar group neutralized with a counterion and the ionic polar group is selected from the group consisting of a sulfonate, a phosphate, a phosphinate, and a phosphonate.

35. The polyester composition of claim 30 wherein X is the ionic polar group neutralized with a counterion and the ionic polar group is a carboxylate having an organic protective group attached thereto or having been added in excess.

36. The polyester composition of claim 30 wherein X is the ionic polar group neutralized with the counterion and the ionic polar group is selected from the group consisting of 3-sulfobenzoic acid, 2-sulfobenzoic acid, 4-sulfobenzoic acid, 3,5-disulfobenzoic acid, 2-bromo-5-sulfobenzoic acid, 2-hexadecyloxy-5-sulfobenzoic acid, 2-hexadecylthio-5-sulfobenzoic acid, and 4-[4-sulfophenoxy-(4-phenoxy)]-benzoic acid.

37. The polyester composition of claim 30 wherein X is the ionic polar group neutralized with the counterion and the counterion is selected from the group consisting of lithium, sodium, potassium, calcium, magnesium, cobalt, zinc, copper, manganese, iron, nickel, tin, titanium, and ammonium.

38. The polyester composition of claim 30 wherein the polar chain terminator is an alcohol, the branching agent is acidic, the polar chain terminator and the branching agent are pre-reacted stoichiometrically to form an ester, and the ester is added as a concentrate to a base polyester composition to form polymer chains by transesterification.

39. The polyester composition of claim 30 wherein the branching agent is trimesic acid or trimelletic anhydride.

40. The polyester composition of claim 30 wherein the polar chain terminator is an acid, the branching agent is alcoholic, the polar chain terminator and the branching agent are pre-reacted stoichiometrically to form an ester, and the ester is added as a concentrate to a base polyester composition to form polymer chains by transesterification.

41. The polyester composition of claim 39 wherein the polar chain terminator is 3-sodiosulfobenzoic acid and the branching agent is glycerol or pentaerythritol.

42. A fiber made of the polyester composition of claim 30.

43. A profile made of the polyester composition of claim 30.

44. A film or sheet made of the polyester composition of claim 30.

45. An injection molded article made of the polyester composition of claim 30.

46. A calendered film made of the polyester composition of claim 30.

47. An extrusion blow molded article of the polyester of claim 30.

48. A blown film made of the polyester composition of claim 30.
